(19) United States
(12) Patent Application Publication
(10) Pub. No.: US 2013/0032428 A1
(43) Pub. Date: Feb. 7, 2013

(54) Automatic engine lock of electric motorcycle

(71) Applicants: Jin Tzeng Woo, Changhua (TW); Jung Feng Lin, Changhua (TW)

(72) Inventors: Jin Tzeng Woo, Changhua (TW); Jung Feng Lin, Changhua (TW)

(21) Appl. No.: 13/421,853

(22) Filed: Mar. 15, 2012

(30) Foreign Application Priority Data
Aug. 5, 2011 (TW) 100214449

(51) Int. Cl. B62H 5/00

(52) U.S. Cl. 180/287

(57) ABSTRACT

An electric motorcycle is provided with a battery; an electric motor; a speed regulation control electrically interconnecting the electric motor and the battery; a padded seat including a bracket and a space defined under the seat; and a safety switch including a housing threadedly secured to the bracket from below, a support tube disposed on a central portion of the housing and partially disposed in the bracket, a cup-shaped spring-activated member slidably put on the support tube and engaging the seat, two laterally extending contacts formed on the spring-activated member, a first contact member disposed under one laterally extending contact and having one end electrically connected to the electric motor, a second contact member disposed under the other laterally extending contact and having one end electrically connected to the speed regulation control, and two receptacles disposed in the housing for anchoring the first and second contact members therein.

### BACKGROUND OF THE INVENTION

1. Field of the Invention

The invention relates to electric motorcycles and more particularly to an electric motorcycle having a lock for automatically locking the electric motor when a seat of the electric motorcycle is not seated.

2. Description of Related Art

Electric motorcycles are high fuel economy equivalents. Also, electric motorcycles are nearly silent, zero-emission.

However, a drawback has been found in the conventional electric motorcycle. In detail, a rider may be not aware that the vehicle is still on or off after leaving the vehicle because the electric motor is nearly silent. It is possible that a child may operate an unattended vehicle which is still on. This is dangerous.

Thus, a need for providing a mechanism for automatically locking an electric motorcycle after a rider leaving same exists.

### SUMMARY OF THE INVENTION

It is therefore one object of the invention to provide an electric motorcycle comprising a battery; an electric motor; a speed regulation control electrically interconnecting the electric motor and the battery; a padded seat comprising a bracket and a space defined under the seat; and a safety switch comprising a housing threadedly secured to the bracket from below, a support tube disposed on a central portion of the housing and partially disposed in the bracket, a cup-shaped spring-activated member slidably put on the support tube and engaging the seat, two laterally extending contacts formed on the spring-activated member, a first contact member disposed under one laterally extending contact and having one end electrically connected to the electric motor, a second contact member disposed under the other laterally extending contact and having one end electrically connected to the speed regulation control, and two receptacles disposed in the housing for anchoring the first and second contact members therein; wherein the laterally extending contacts electrically contact the first and second contact members respectively when the spring activated member moves along the support tube by pressing the seat.

The above and other objects, features and advantages of the invention will become apparent from the following detailed description taken with the accompanying drawings.

### BRIEF DESCRIPTION OF THE DRAWINGS

FIG. 1 is a schematic circuit diagram of an electric motorcycle, the circuit being open when a seat of the electric motorcycle is unoccupied according to the invention;

FIG. 2 is a view similar to FIG. 2 where the circuit is closed after a rider sitting on the seat;

FIG. 3 is a perspective view showing location of the safety switch within the seat of the electric motorcycle;

FIG. 4 is a longitudinal sectional view of an intermediate portion of the FIG. 3 showing the safety switch being open when the seat of the electric motorcycle is unoccupied; and

FIG. 5 is a view similar to FIG. 4 showing the safety switch being closed when the seat of the electric motorcycle is seated.

### DETAILED DESCRIPTION OF THE INVENTION

Referring to FIGS. 1 to 5, an automatic engine lock of an electric motorcycle in accordance with the invention is shown. Components of the engine lock and the electric motorcycle are discussed in detail below.

A battery (e.g., rechargeable battery) 10 is provided. Two handlebars 30 (only one shown) are provided in which one handlebar 30 can be rotated to regulate a rotation speed of an electric motor 40 via a speed regulation control 20 when a safety switch 50 is on in which the speed regulation control 20 is electrically interconnected the battery 10 and the electric motor 40. A seat 60 comprises a plate bracket 62, a pad 61 provided on the plate bracket 62, and a space 63 defined under a curvy bottom of the pad 61. The safety switch 50 is provided within the seat 60 as detailed below.

The safety switch 50 comprises a housing 51 threadedly secured to the plate bracket 62 from below, a hollow support tube 510 formed on a central portion of the housing 51 and partially disposed in the plate bracket 62, a torsion spring 52 having one end anchored on the bottom of the support tube 510, an inverted cup-shaped sliding member 53 put on the support tube 510 to be biased by the other end of the spring 52 so as to urge against the bottom of the pad 61 after inserting through the plate bracket 62 into the space 63, two opposite contacts 54 provided on two wing portions of the sliding member 53 (i.e., the sliding member 53 disposed between the contacts 54), a first contact member 55 disposed under one contact 54 and having one end electrically connected to a positive terminal of the electric motor 40 via a first conductor (indicated by IN) 57, a second contact member 56 disposed under the other contact 54 and having one end electrically connected to a positive terminal of the speed regulation control 20 via a second conductor (indicated by OUT) 58, two receptacles 511 formed on the bottom of the housing 51 with the support tube 510 disposed therebetween, and two torsions springs 59 in which one spring 59 having one end anchored in one receptacle 511 and the other end secured to the first contact member 55, and the other spring 59 having one end anchored in the other receptacle 511 and the other end secured to the second contact member 56. One contact 54 is not in contact with the first contact member 55 and the other contact 54 is not in contact with the second contact member 56 respectively when the seat 60 is not pressed by an individual (e.g., rider).

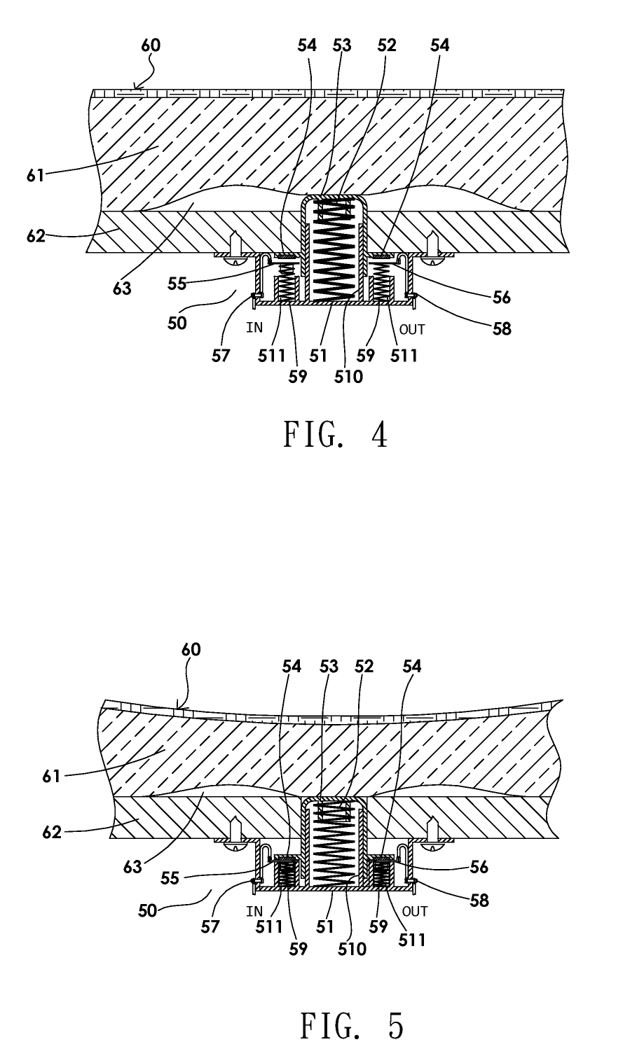

Operations of the invention will be described in detail below. The circuit of the invention is open as shown in FIG. 1 when a rider does not sit on the seat 60. Thus, the electric motor 40 will not supply power to the drive mechanism of the vehicle even when a key is still in the key hole with the electric motor 40 being activated (i.e., the driver leaving the vehicle without removing the key to deactivate the electric motor 40 due to carelessness). This is because one contact 54 is not in contact with the first contact member 55 and the other contact 54 is not in contact with the second contact member 56 respectively when the seat 60 is not seated by the rider (see FIG. 4).

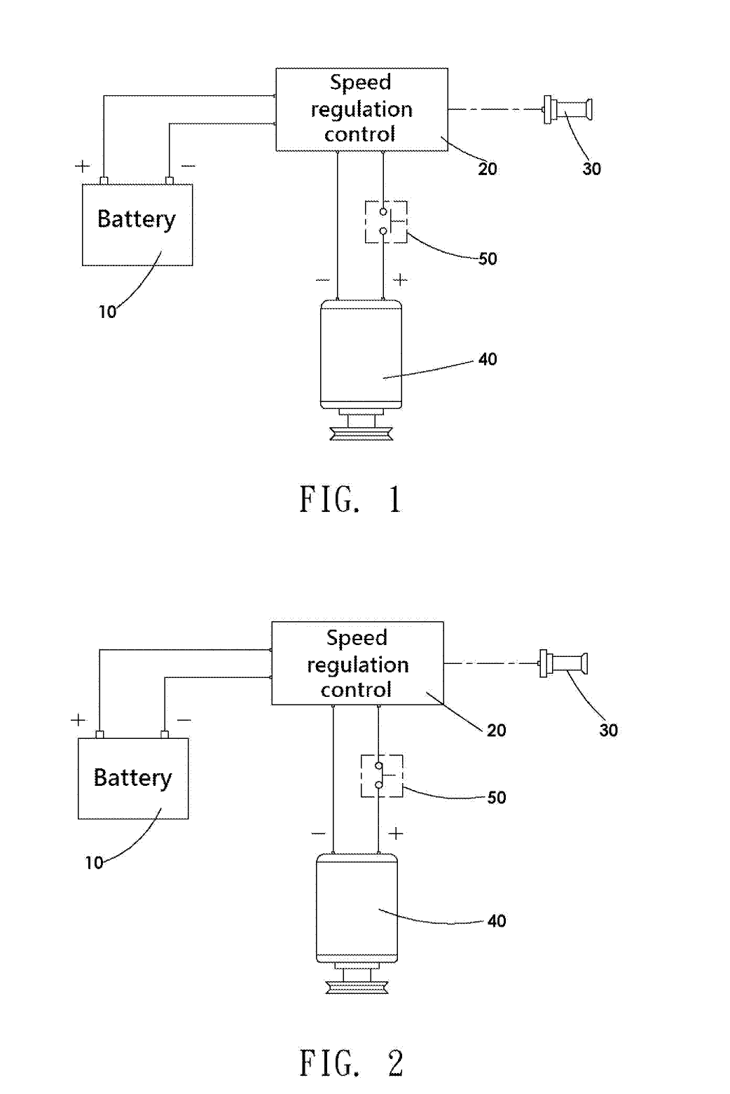

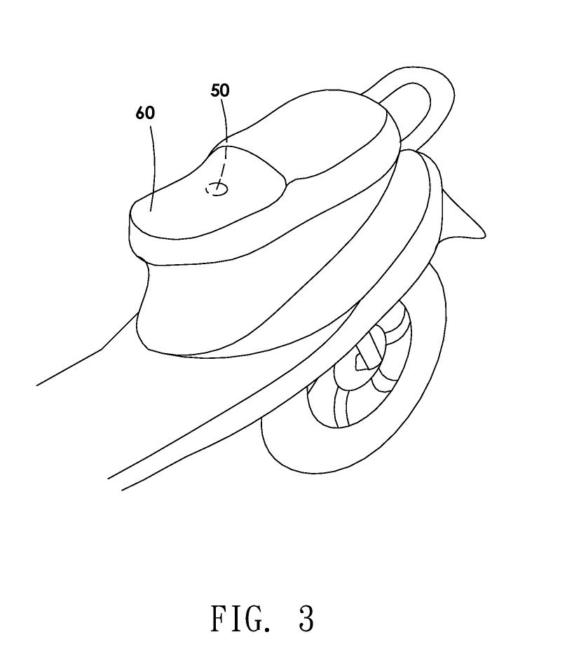

To the contrary, the pad 61 is elastically deformed to decrease the space 63 and press down the sliding member 53 along the support tube 510 with the spring 51 being compressed when the rider sits on the seat 60. And in turn, the contacts 54 lower to contact the first and second contact members 55 and 56 respectively. As a result, the circuit of the invention is closed as shown in FIG. 2. Further, the first and second contact members 55 and 56 are pressed downward by the contacts 54 to compress the springs 59 until the first and second contact members 55 and 56 are stopped by tops of the receptacles 511 respectively. Thus, the electric motor 40 supplies power to the drive mechanism of the vehicle after inserting the key in the key hole to start the electric motor 40 (see FIG. 4). It is understood that locations of the components shown in FIG. 4 will return to that shown in FIG. 3 after the rider leaving the seat 60.

It is envisaged by the invention that an electric motorcycle cannot be activated when a seat thereof is not seated.

While the invention has been described in terms of preferred embodiments, those skilled in the art will recognize that the invention can be practiced with modifications within the spirit and scope of the appended claims.

What is claimed is:

1. An electric motorcycle comprising:
a battery;
an electric motor;
a speed regulation control electrically interconnecting the electric motor and the battery;
a padded seat comprising a bracket and a space defined under the seat; and
a safety switch comprising a housing threadedly secured to the bracket from below, a support tube disposed on a central portion of the housing and partially disposed in the bracket, a cup-shaped spring-activated member slidably put on the support tube and engaging the seat, two laterally extending contacts formed on the spring-activated member, a first contact member disposed under one laterally extending contact and having one end electrically connected to the electric motor, a second contact member disposed under the other laterally extending contact and having one end electrically connected to the speed regulation control, and two receptacles disposed in the housing for anchoring the first and second contact members therein;
wherein the laterally extending contacts electrically contact the first and second contact members respectively when the spring activated member moves along the support tube by pressing the seat.

2. The electric motorcycle of claim 1, wherein each of the first and second contact members is spring-activated.
